(19) United States
(12) Patent Application Publication
(10) Pub. No.: US 2009/0061938 A1
(43) Pub. Date: Mar. 5, 2009

(54) Apparatus and method for determining a utilized transmission capacity of a base transceiver station

(76) Inventors: Gerald Ulbricht, Leinburg-Diepersdorf (DE); Georg Seegerer, Taennesberg (DE)

Correspondence Address: GLENN PATENT GROUP, 3475 EDISON WAY, SUITE L, MENLO PARK, CA, 94025, US

(21) Appl. No.: 12/200,628

(22) Filed: Aug. 28, 2008

(30) Foreign Application Priority Data
Aug. 28, 2007 (DE) 102007040419.2

(51) Int. Cl. H04B 1/38

(52) U.S. Cl. 455/561

(57) ABSTRACT

Apparatus for determining a utilized transmission capacity of a base transceiver station for transmitting a transmit signal, having a receiver, with which the transmit signal is receivable, and a detector for checking a number of utilizable transmit channels from the transmit signal for utilization thereof. The apparatus further includes a calculating unit for calculating the utilized transmission capacity based on a result of the check.

### CROSS-REFERENCE TO RELATED APPLICATIONS

This application claims priority from German Patent Application No. 102007040419.2, which was filed on Aug. 28, 2007, and is incorporated herein in its entirety by reference.

### BACKGROUND OF THE INVENTION

The present invention relates to the determination of utilized transmission capacities as it may be performed at base transceiver stations of mobile radio systems, for example.

Even the present dimensions of mobile radio systems, which have become indispensable both in the commercial and private sectors of society, necessitate a very complex infrastructure. Throughout the world, the use of mobile radio systems is continuously increasing and therefore necessitates continuous development of the respective mobile radio infrastructure, i.e. the respective base station and antenna systems. A growing number of mobile radio providers are simultaneously striving to get hold of a share of the market. If a growing number of mobile radio providers wish to guarantee area-wide supply, the result will be that the infrastructure needs to be increasingly developed, i.e. more and more base stations and antennas will be built. In some countries, it has become difficult to enforce further transmitter sites against the will of environmental activists and citizens' initiatives. In other countries “uncontrolled growth” of transmitter towers, which mar both cityscapes and landscapes, has developed. For example, the city of Jakarta in Indonesia has made the shared use of transmitting plants a condition for the mobile radio providers. There, existing transmitting plants even have to be dismantled.

One approach for ensuring the coexistence of a multitude of mobile radio providers, with the infrastructure remaining manageable, is to prescribe the shared use of, e.g., transmit antenna systems to the providers. As the market shares of the various mobile radio providers are to some extent very divergent, it is desired here to detect the radio communications of the different providers and to distribute and adjust among same the investment and operating costs in accordance with the volume of data traffic in each case. The problem here is that it is difficult, i.e. possible with substantial technical complexity only, to extract this information from the call data, and that, on the other hand, same is not desired by the mobile radio providers as the transmitted data is to be kept secret, for example.

In the case of a shared use of transmitter towers or containers already, a detection of such a provider-dependent volume of data traffic may be of interest as far as the infrastructure is concerned. For the above-mentioned reasons, however, what is of particular interest is the shared use of antenna systems or antenna structures.

FIG. 7 illustrates a scenario with two base transceiver stations 710 and 720, which are also designated with “BTS1” and “BTS2” (BTS=Base Transceiver Station). The base transceiver station 710 is provided with a receive section 712, which is also designated with “RX” (RX=receiver) and a transmit section 714, which is also designated with “TX” (TX=transmitter). Starting from the two transmit stages 714 and 724, the two transmit signals of the two base transceiver stations 710 and 720 are combined via a combiner 730 and conducted to the antenna 750 via a branching filter 740. In the process, the branching filter 740, which is also designated with “RX/TX filter”, separates transmit and receive signals, i.e. signals coming from the combiner 730 are forwarded to the antenna 750, and signals coming from the antenna 750 are first conducted to a radio-frequency input amplifier 760, which is also designated with “LNA” (Low Noise Amplifier). The output signal of the radio frequency amplifier 760 is then split up in a splitter 770 and supplied to the two receive stages 712 and 722 of the two base transceiver stations 710 and 720.

FIG. 7 shows one of several ways of how two or even multiple base transceiver stations can utilize a common antenna. The receive signal coming from the antenna 750, is, after the branching filter 740, which may e.g. be realized by a duplex filter, first amplified in a low-noise manner and then supplied to the receivers 712 and 722 of the base transceiver stations 710 and 720 via a common power divider or splitter 770, wherein, in principle, multiple base transceiver stations are also conceivable. The transmit signals of the base transceiver stations 710 and 720 and/or of the further base receiver stations are merged via a combiner 730 and then supplied to the antenna 750 via the branching filter 740. The combiner 730 may be realized by a filter combiner or a hybrid combiner, for example.

As a rule, filter combiners represent tunable filters with very steep slopes, which may involve respective drawbacks. As a rule, hybrid combiners exhibit high intrinsic attenuation, so that other solutions between the base transceiver stations are also used in practice.

FIG. 8 shows a scenario similar to that of FIG. 7. Unlike FIG. 7, in the base transceiver stations of FIG. 8, a power output state is not integrated into the transmit stages 714 and 724, so that the signals of the transmit path may be merged even before the power amplifier, e.g. by a hybrid combiner 730. A power amplifier 780 then only follows after a combination of the transmit signal in the combiner 730. For example, a multi-carrier power amplifier 780 which, in FIG. 8, is also designated with MCPA=multi-carrier power amplifier) may also be employed as the power amplifier 780. The drawback of such an approach is that there are high demands on the linearity of the power amplifier 780.

In the field of conventional technology, there are several ways of utilizing antennas by multiple base stations. However, with regard to the future development of mobile radio systems, what is problematic is the determination of the utilization proportion of an antenna that is simultaneously used by multiple base transceiver stations.

The concepts of conventional technology do not allow for efficient charging of the investment and operating costs for a shared mobile radio infrastructure, such as containers, transmitter towers, antennas, etc., in accordance with utilization by the different providers.

### SUMMARY

According to an embodiment, an apparatus for determining a utilized transmission capacity of a base transceiver station for transmitting a transmit signal may have: a receiver, with which the transmit signal is receivable; a detector for checking a number of utilizable transmit channels from the transmit signal for utilization thereof; and a calculating unit for calculating the utilized transmission capacity based on a result of the check.

According to another embodiment, a method of determining a utilized transmission capacity of a base transceiver station for transmitting a transmit signal may have the steps of: receiving the transmit signal; checking a number of utilizable transmit channels from the transmit signal for utilization thereof; and calculating the utilized transmission capacity based on a result of the check.

An embodiment may have: a computer program with a program code for performing, when the program code runs on a computer, the method of determining a utilized transmission capacity of a base transceiver station for transmitting a transmit signal, the method including: receiving the transmit signal; checking a number of utilizable transmit channels from the transmit signal for utilization thereof; and calculating the utilized transmission capacity based on a result of the check.

According to another embodiment, an apparatus for determining a utilized transmission capacity of a base transceiver station for receiving a receive signal may have: a receiver, with which the receive signal is receivable; a detector for checking a number of utilizable receive channels from the receive signal for utilization thereof; and a calculating unit for calculating the utilized transmission capacity based on a result of the check.

According to another embodiment, a method of determining a utilized transmission capacity of a base transceiver station for receiving a receive signal may have the steps of: receiving the receive signal; checking a plurality of utilizable receive channels from the receive signal for utilization thereof; and calculating the utilized transmission capacity based on a result of the check.

An embodiment may have: a computer program with a program code for performing, when the computer program runs on a computer, the method of determining a utilized transmission capacity of a base transceiver station for receiving a receive signal, the method including: receiving the receive signal; checking a plurality of utilizable receive channels from the receive signal for utilization thereof; and calculating the utilized transmission capacity based on a result of the check.

Another embodiment may have: a system for determining a utilized transmission capacity of a base transceiver station with an apparatus for determining a utilized transmission capacity of a base transceiver station for transmitting a transmit signal, the apparatus including: a receiver, with which the transmit signal is receivable; a detector for checking a number of utilizable transmit channels from the transmit signal for utilization thereof; and a calculating unit for calculating the utilized transmission capacity based on a result of the check.

Another embodiment may have: a system for determining a utilized transmission capacity of a base transceiver station with an apparatus for determining a utilized transmission capacity of a base transceiver station for receiving a receive signal, the apparatus including: a receiver, with which the receive signal is receivable; a detector for checking a number of utilizable receive channels from the receive signal for utilization thereof; and a calculating unit for calculating the utilized transmission capacity based on a result of the check.

The central idea of the present invention consists in the fact that a utilized transmission capacity of a base transceiver station is checkable from the outside by evaluating receive signals and/or transmit signals. In base transceiver stations, FDMA (Frequency Division Multiple Access), TDMA (Time Division Multiple Access), CDMA (Code Division Multiple Access), OFDMA (Orthogonal Frequency Division Multiple Access) etc. are used. Based on the knowledge of the multiple access method, active transmit channels may be detected from receive and/or transmit signals, whereby a utilization of transmission capacities may be determined. The utilized transmission capacities determined such may then give information about which base station has which utilization proportion of a shared antenna.

Embodiments of the present invention provide the advantage that utilization capacities of base transceiver stations at antennas may be determined from outside without detecting the payload data transmitted. For example, embodiments may determine no more than an activity of transmit channels without detecting the data actually transmitted in these transmit channels. In embodiments, so-called dummy data, which is transmitted in order to operate a transmit output stage in a certain frequency range at a power that is as constant as possible and to avoid non-linearities in the amplifier characteristic curve, may only be distinguished from actual payload data. Embodiments may accomplish this differentiation without detection of the payload data.

### BRIEF DESCRIPTION OF THE DRAWINGS

Embodiments of the present invention will be detailed subsequently referring to the appended drawings, in which:

FIG. 1 shows an embodiment of an apparatus for determining a utilized transmission capacity of a base transceiver station;

FIG. 2 shows an embodiment of an apparatus for determining a utilized reception capacity of a base transceiver station;

FIG. 3 shows an embodiment of a scenario with an apparatus for determining a utilized transmission capacity and an apparatus for determining a utilized reception capacity of a base transceiver station;

FIG. 4 shows a further embodiment for determining a transmission capacity at multiple frequencies;

FIG. 5 shows an embodiment of an apparatus for determining a transmission capacity with analog-to-digital conversion;

FIG. 6 shows a further embodiment of an apparatus for determining a transmission capacity with a complex mixer;

FIG. 7 shows a scenario of a conventional antenna shared by two base transceiver stations; and

FIG. 8 shows a further scenario of an antenna shared by two base transceiver stations.

### DETAILED DESCRIPTION OF THE INVENTION

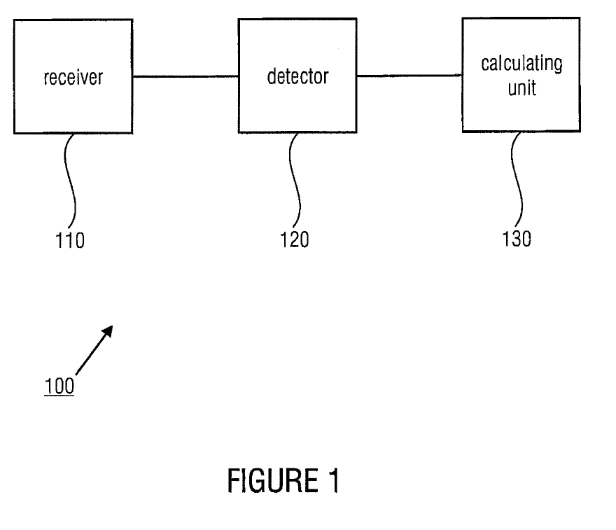

FIG. 1 shows an apparatus 100 for determining a utilized transmission capacity of a base transceiver station for transmitting a transmit signal, having a receiver 110, with which the transmit signal is receivable, and a detector 120 for checking a number of utilizable transmit channels from the transmit signal for utilization thereof. The apparatus 100 further includes a calculating unit 130 for calculating the utilized transmission capacity based on a result of the check.

In embodiments, the detector 120 may be configured for checking the utilization of the utilizable transmit channels independently of data transmitted in the transmit channels. This means that, even though subscriber channels are tested for activity, the actual data of the subscribers is not decrypted or detected. Rather, in embodiments, the detector 120 may be configured for checking the transmit signal for utilized frequencies, time slots or codes, wherein a transmit channel may be allocatable to a frequency, a time slot, a code, a plurality of frequencies or a combination thereof. Here, the detector may be configured for checking the transmit signal according to the standards of GSM (Global System for Mobile Communications), according to UMTS (Universal Mobile Telecommunication System), according to LTE (Long Term Evolution), for example, all of which are provided with respective specifications, for the utilization of transmit channels. Here, embodiments are not limited to the mobile radio systems mentioned, same solely represent examples of specified mobile radio systems or mobile radio systems in the process of being specified. As a rule, other standards or specifications, such as IEEE 802.11, IS 95 etc., are also conceivable.

In embodiments, the detector 120 may further be configured for checking a utilization of a transmit channel by means of a power detection in the transmit channel. The receiver 110 may, in embodiments, comprise a receive antenna for receiving the transmit signal. In this case, a receive antenna, which receives the transmit signal of the base receive station and supplies same to the receiver 110, could be disposed near the base transceiver station. In another embodiment, the receiver 110 may comprise a directional coupler or power divider, which is couplable into the transmit path of a base transceiver station to couple a respective transmit signal there. An attenuator for attenuating the transmit signal may also be used, for example. In further embodiments, the apparatus 100 may further comprise a modem detecting information from the transmit signal, such as an identifier of the base transceiver station which, in turn, the utilized frequencies, time slots or similar system parameters may be inferred from. The modem may, in embodiments, be configured for determining the utilizable transmit channels from a control channel of the base transceiver station.

In embodiments, the receiver 110 may further comprise a mixer coupled to a local oscillator, in order to downmix the transmit signal, which may e.g. be present in the transmission band, to an intermediate frequency range or a base band range. The mixer may also be configured as a quadrature mixer or complex mixer, for example. In other embodiments, it would be conceivable that the receiver 110 comprise a plurality of mixers or local oscillators in order to mix signals of different carrier frequencies to respective intermediate frequency or base band ranges. It would also be conceivable to use a tunable local oscillator with a mixer. For filtering out a receive signal, different filters may be used. What would, e.g., be conceivable is a channel filter for filtering a receive signal, which is tuned to a certain time slot, frequency or code, etc. For receiving a respective variety of receive channels, the receiver 110 may further comprise a plurality of channel filters for filtering a plurality of receive channels.

In embodiments, the detector 120 may comprise a power detector and, in dependence on a detection of a multitude of receive channels, the detector 120 may comprise a respective multitude of power detectors. In further embodiments, a threshold-value decision unit or analog-to-digital converter may precede the calculating unit 130. It would also be conceivable that the detector 120 comprise synchronization means for a synchronization with a waveform or temporal frame structure of the transmit signal so as to forward, e.g. during a transmit channel, exactly one or several or a predetermined number of samples to the calculating unit. It would, e.g., be conceivable that information on the utilizable transmit channels be transferred from a user interface, i.e. that the apparatus 100 be configured with the information on the utilizable transmit channels from the outside. In a further embodiment, it would also be conceivable that the information on the utilizable transmit channels be received by the modem.

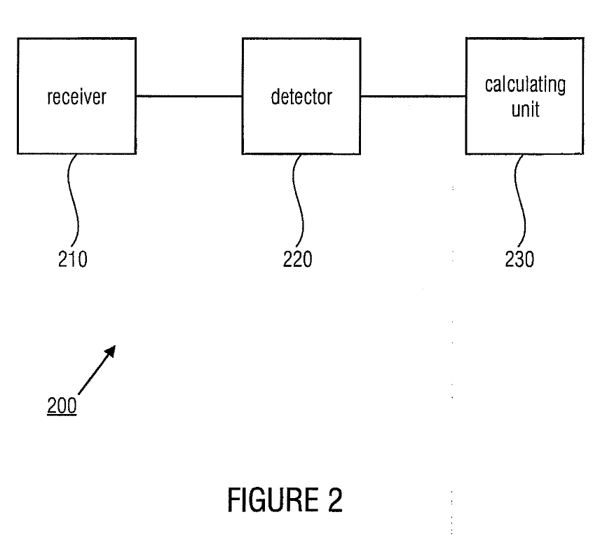

The above explanations following FIG. 1 referred to a determination of a transmission capacity, i.e. evaluation of transmit signals. In a further configuration, the present invention also comprises an apparatus 200 for determining a utilized transmission capacity of a base transceiver station for receiving a receive signal, as it is discussed in greater detail in the embodiment of FIG. 2. FIG. 2 shows an apparatus 200 for determining a utilized transmission capacity of a base transceiver station for receiving a receive signal, having a receiver 210 with which the received signal is receivable, and a detector 220 for checking a number of utilizable receive channels from the receive signal for utilization thereof. The apparatus 200 further comprises a calculating unit 230 for calculating the utilized transmission capacity based on a result of the check.

The detector 220 may be configured in a manner similar to the configurations of the detector 120 described above. In embodiments, the detector 220 may e.g. be configured for checking the utilization of the utilized transmit channels independently of the received data in the receive channels. The detector 220 may be configured for checking the receive signal for utilized frequencies, time slots or codes, wherein a receive channel is allocatable to a frequency, a time slot, a code, a plurality of frequencies or a combination thereof. Here too, the detector 220 may be configured for checking receive signals for the utilization of receive channels in accordance with the above-mentioned standards GSM, UMTS, LTE, 802.11, IS 95, IS 136, etc. The utilization of a receive channel may be effected via power detection in the receive channel. The receiver 220 may comprise a low-noise receiving amplifier (LNA), which receives a separate receive signal via a separate receive antenna, for example, or is connected into the receiving branch of the base transceiver station. In a further embodiment, the receiver 210 may comprise a directional coupler or power divider, which is couplable into the receiving branch of the base transceiver station, in order to couple out the receive signal.

In these embodiments too, the receiver 210 may comprise a mixer and a local oscillator. In embodiments, the mixer may be configured as a quadrature mixer or a complex mixer, in a further embodiment, a plurality of mixers and local oscillators is also conceivable, in order to mix a plurality of frequencies to an intermediate frequency range or base band range. Here too, tunable local oscillators may be used. For filtering the receive channels, channel filters, for example, may be use. In embodiments, a plurality of channel filters for filtering a respective plurality of receive channels may be present in the receiver 210. In embodiments, the detector 220 may comprise one single power detector or a plurality thereof. Here too, the calculating unit 230 may be preceded by a threshold-value decision unit or an analog-to-digital converter, which may be synchronized, with respect to a waveform or temporal frame structure of the receive signal, e.g. to the detector 220 by means of synchronization means. Here too, it would be conceivable that the detector 220 be given the information on the utilizable receive channels from the outside, i.e. that same have a user interface, via which the respective receive channels may be given. In a further embodiment, it would be conceivable that this information be received by a respective modem.

Embodiments of the present invention provide the opportunity of thus detecting the proportional utilization by different providers of a common transmit antenna, for example, in order to fairly distribute the costs.

In the following, embodiments are discussed in detail using a GSM network as an example. The approach is only exemplarily described using GSM mobile radio base stations as the example. It may equally be translated to other methods, in particular TDMA methods such as the IS 136. In a GSM network, in a certain area, individual frequency ranges, which are assigned in pairs for the uplink and the downlink, and therefore a precisely defined number of frequency channels are allocated to a certain provider. For example, in Germany, these channels are presently, throughout the country, assigned to the four mobile radio providers T-Mobil, Vodafone, e-Plus and 02.

If a signal is detected at a certain frequency within a certain frequency channel, which in the case of GSM includes 200 kHz of bandwidth, same may unambiguously be allocated to one of the four providers.

GSM realizes an FDMA/TDMA system, GSM therefore also has a time slot component, i.e. a time domain multiple access method, which means that the communication between the base transceiver station and the mobile terminal device takes place in short time slots. In GSM, a time slot has a duration of just under 577 μs. Eight successive time slots result in a so-called frame, which has a duration of approximately 4.6 ms. This means that, usually, only every eighth time slot is used for the communication with a terminal device. An exception to this is the packet data transmission, which may be effected via GPRS (General Packet Radio Service) in the domain of the GSM mobile radio networks. In this data transmission, multiple time slots are allocated to a terminal device, thus achieving higher data rates. In the respective other time slots, communication to other terminal devices takes place. This, in the field of normal voice links, serves to establish a maximum of eight terminal devices, i.e. eight links, per frequency channel. Here, again in the field of the GSM networks, there is another exception, namely halfrate transmission. In this mode of operation, only half the data rate is used for the voice transmission, which, although it may entail impairment of quality, serves to supply two users with voice data in one time slot.

The time slot method manifests itself in the fact that a signal is transmitted only when a link to a mobile terminal device was allocated to a time slot. Exceptions are the so-called broadcast channels. The base transceiver station transmits with maximum power at least one frequency in all time slots, so that the terminal devices may in each case receive a signal on this channel, which is important should the mobile radio terminal devices attempt to register with a cell, for example, and for this purpose scan/search the entire frequency band. This frequency channel, which a certain frequency is allocated to, is often called BCCH (Broadcast Control Channel). At this frequency, the so-called broadcast control channel, which contains all essential information for a mobile radio terminal device to register with the respective cell, is transmitted. In the case that less than seven terminal devices maintain voice or data links in a cell, dummy data, which may, however, be distinguished from the user data, is transmitted in the free time slots.

In accordance with this, in embodiments, in order to detect the data traffic within a radio cell, the number of active time slots within a time period is detected and added up. Same may occur both in the signals emitted from a base transceiver station and in signals received by a base transceiver station. It is to be noted that the above-mentioned dummy data is not present in the receive signals of a base transceiver station, so that, here, simple detection may be effected by a power detector, for example. It is therefore possible to detect the signals coming from the terminal devices in the time slots thereof, which are only active if data traffic is actually taking place.

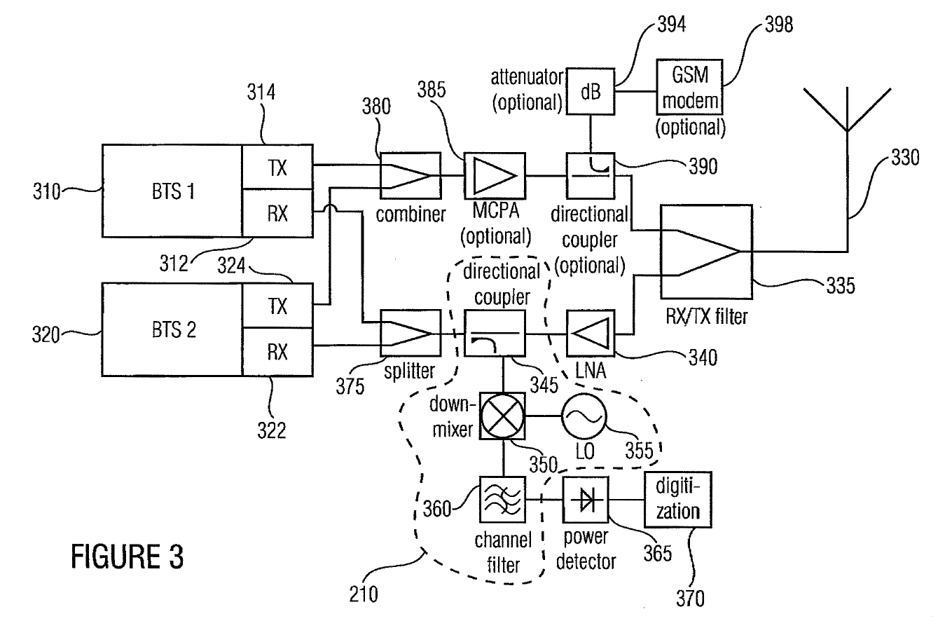

FIG. 3 shows an embodiment of such an apparatus for determining a utilized transmission capacity. FIG. 3 shows a first base transceiver station 310 with a receive section 312 and a transmit section 314. Furthermore, FIG. 3 shows a second base transceiver station 320, which also has a receive section 322 and a transmit section 324. As described above, the signals are received and transmitted via an antenna 330, and divided up into transmit and receive signals in a branching filter 335, which is also termed an RX/TX filter. Therefore, in the path of the receive signals, there is first a low-noise radio frequency amplifier 340 (LNA), which is followed by a directional coupler 345. The directional coupler 345 couples a portion of the power of the receive signal amplified by the LNA 340 out of the receiving branch and supplies same to a downmixer 350. The downmixer 350 is further connected to a local oscillator 355 and a channel filter 360.

The arrangement of the directional coupler 345, the downmixer 350, the local oscillator 355 and the channel filter 360 is an embodiment of a receiver 210, with which the receive signal is receivable, and of an apparatus for determining a utilized transmission capacity of a base transceiver station. The downmixer 350, in combination with the local oscillator 355, realizes a conversion of the receive signal from the transmission band to an intermediate frequency range or a base band range. The frequency of the local oscillator 355 may depend on the receive channel to be selected, wherein the receive channel is then variable via a tunable local oscillator 355 so that one may switch between the receive channels of the two base transceiver stations 310 and 320. The channel filter 360 is followed by a power detector 365 for checking a number of utilizable receive channel from the receive signal for utilization thereof. For example, the power detector detects the power in a receive channel. The power detector 365 is followed by a calculating unit or digitization 370 for calculating the utilized transmission capacity based on the result of the checking of the power detector 365.

In analogy to the above description, there is a splitter 375 in the receive path, which indicates the receive signals to the two receive stages 312 and 322 of the two base transceiver stations 310 and 320. The two transmit signals of the transmit stages 314 and 324 are combined by a combiner 380 and amplified by a multi-carrier power amplifier 385 (MCPA). Again, from the transmit signal present at the output of the power amplifier 385, a portion of the power may be coupled out by a directional coupler 390, the portion then being supplied to a GSM modem 398 via an optional attenuator 394. The attenuator 394 is optional and serves for attenuating the coupled-out transmit signal for adjustment thereof to an input of the GSM modem 398. The GSM modem 398 is also optional and serves for the detection of information from the transmit signal, such as from the BCCH, in order to extract information on the base transceiver stations regarding utilizable transmission capacities thereof. After the directional coupler 390, the transmit signal passes the branching filter 335 and is subsequently emitted via the antenna 330.

In an embodiment, the receive signal coming from the antenna 330 is, after the branching filter 335, amplified in a low-noise manner by means of the receiving amplifier 340, in order to obtain optimum sensitivity. After that, a portion of the signal may be coupled out by the directional coupler 345, wherein a power divider may alternatively be used. The coupled-out signal is brought into, e.g., a suitable intermediate frequency range via the downmixer 350. Subsequently, undesired frequency components may be rejected by means of the channel filter 360 so that only the desired frequency channel is present in the output signal of the channel filter 360, as far as this is possible. In embodiments, the channel filter 360 may by all means be narrower than the bandwidth of a channel stipulated by a respective standard. It may, however, be important that it be sufficiently rejected in the next occupied frequency channel so as not to corrupt the measurement result as, in GSM for example, the next and in most cases the next by one channel in a cell is not occupied.

This may particularly be important in the detection of a receive signal, as here, dependent on the distance of the terminal devices, the signal in the next occupied channel may be significantly higher than the signal to be detected. After the channel filter 360, the power may be converted to a voltage dependent on the input power, for example by a power detector 365. In embodiments, the logarithmic power detectors would be a suitable choice as they are able to very accurately detect power across a very large dynamic range of several 10 dB.

In embodiments, the output voltage of the power detector 365 may optionally be smoothed via a low-pass filter. This may in turn be important in the measurement of EDGE (Enhanced Data Rates for GSM Evolution) signals, as EDGE signals enable a data rate increased by the factor 3 in the GSM network. In these signals, the amplitude, in contrast to conventional GMSK (Gaussian Minimum Shift Keying) modulations, may not be constant within a time slot. With suitable choice of the time constant of the optional low pass, the amplitude modulation in the EDGE signal may be largely smoothed, whereby measurement accuracy is increased. As already mentioned, the low pass is only optional and may be omitted, for example when the signal is sampled with a sufficient sampling rate and the mean power is calculated, which may be realized by a digitization 370.

The digital detection of the power-dependent output voltage of the detector 365 by the calculating unit 370 may be effected in a variety of ways. For example, in a first embodiment, a simple threshold-value decision could take place, which, e.g., outputs a digital high level when the voltage value exceeds a certain threshold. The threshold value could be positioned such that it corresponds to the limit of sensitivity of the base transceiver station. By means of the digital processing unit 370, these events may be detected. In another embodiment, an analog-to-digital converter, which converts the voltage value to a respective digital value, could be employed.

The detection of the measured values may be effected often enough for each time slot to be reliably detected. This could, e.g., be ensured by a synchronization of the sampling to the time-slot scheme taking place and the level being detected in the center of a time slot, for example. Taking GSM as an example, this would correspond to a measurement rate of 1,733.3 Hz, in other mobile radio systems, respective other frequencies would be yielded. In another embodiment, it would be conceivable to take a measurement often enough for several measurement values to fall upon a single time slot in each case, which, taking GSM as an example, would correspond to a frequency of at least 3,500 Hz.

As already mentioned above, the downmixer 350 and the local oscillator 355 as well as the channel filter 360 serve for converting a receive channel from the transmission band to an intermediate or baseband frequency range. In an embodiment, for determining at which frequency channel measurement is to take place, same may be given by a user interface. In such embodiments, the inventive apparatus therefore has an interface, via which the respective frequency channels may be given from the outside by a respective user. However, as, at base transceiver stations, the frequencies used, and therefore the transmit channels used, may occasionally change, which may, e.g., be the result of extensions of the mobile radio network by additional base transceiver stations, automatic adjustment would also be conceivable. For this purpose, in embodiments, a GSM modem 398 as it is shown in FIG. 3 may be used, for example. As a rule, however, any suitable GSM terminal devices are conceivable in embodiments. Via the directional coupler 390, which is disposed in the transmit path of the two base transceiver stations, a portion of the transmitting power is coupled out, possibly via an attenuator 394, in order to adjust the transmitting power to the sensitivity of the GSM modem 398.

The modem 398 may be in the position, e.g. by means of a scan, i.e. a check of all contemplable frequency ranges, to unambiguously identify the base transceiver station and the frequency channels allocated thereto from the received BCCHs (broadcast channels). This could be effected by the standardized values of Base Station Identification Code (BSIC), Mobile Country Code (MCC) and Mobile Network Code (MNC), Location Area Code (LAC), Cell Identifier and Cell Allocation (CA), for example. Thus, in embodiments, there is information as to at which frequency channels measurements are to be taken and which base transceiver station these measurement values are to be allocated to.

In embodiments, the modem 398 does not necessarily have to be coupled to the transmit path via a coupler or directional coupler 390. In embodiments, it is also possible that the modem 398 receives the signals emitted via the base station antenna via an antenna of its own. In such embodiments, it is further realistic to predefine the BSIC or cell ID via the user interface, as it cannot be ruled out that the modem 398 also receives signals from other base transceiver stations.

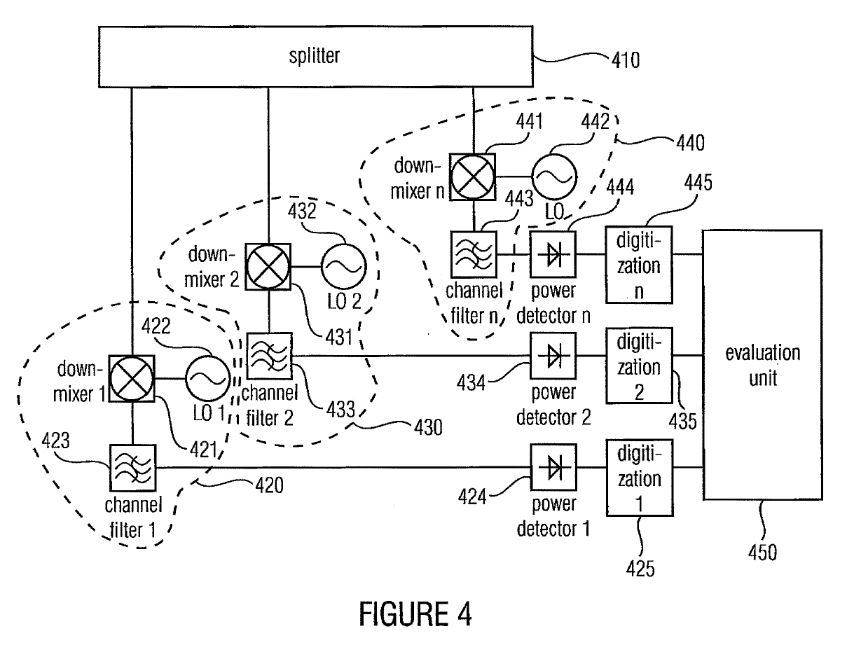

As already mentioned above, the measured frequency channel may be adjusted by a respective choice of the local oscillator 355, for example. Here, in embodiments, again different strategies are conceivable. In an embodiment that achieves relatively high accuracy, a separate downmixer could be used for each frequency channel to be measured. FIG. 4 illustrates such an embodiment. FIG. 4 shows a splitter 410, which should be disposed in the receive path of multiple base transceiver stations. The number of base transceiver stations, in the receive path of which the splitter 410 is to be found, be arbitrary. The splitter 410 is followed by multiple receivers each adapted to the respective frequency channels, wherein, in FIG. 4, the receivers 420, 430 and 440 are represented. Each receiver consists of a downmixer 421, 431, 441, the signal of the splitter 410 is supplied to, and a local oscillator 422, 432, 442. The output signals of the downmixers 421, 431, 441 are followed by a channel filter 423, 433, 443 for extracting the respective frequency channel, wherein, in the embodiment illustrated in FIG. 4, it is assumed that the respective channel filters 423, 433, 443 filter out different frequency channels.

In FIG. 4, each receiver 420, 430, 440 is followed by a power detector 424, 434, 444. Subsequently, in the embodiment of FIG. 4, a digitization of the output signals of the power detectors 424, 434, 444 is effected via the digitizations 425, 435 and 445. The outputs of the digitizations 425, 435, 445 are then supplied to an evaluation unit 450 for evaluation. The evaluation unit 450 represents a calculating unit for calculating the utilized transmission capacity based on the result of the check by the power detectors 424, 434, 444.

FIG. 4 exemplarily shows three receiving branches, in which three frequency channels may be detected. In general, in embodiments, an arbitrary number of receive channels are conceivable, which is meant to be expressed in FIG. 4 by the numbering 1, 2, n. If, in an embodiment, an exemplary ten frequencies were to be monitored, the receive signal would be distributed to ten paths after the coupling out, wherein each channel may then be detected via a separate detector.

More favorably priced embodiments realize the structure shown in FIG. 4 with one single path, wherein, here, a fast switching local oscillator may be employed, which is able to detect all or at least multiple channels within a time slot. This may, for example, be enabled by the fact that the demands on the phase noise and the spectral purity of the local oscillator are not very high. A transient behavior of such a local oscillator and the time constant of a low pass possibly employed before the detectors could be correspondingly adjusted in such embodiments.

Alternatively, in embodiments which take measurements over a longer period of time, a favorably priced realization could be achieved if only one channel each is detected per time slot, and afterwards a quasi random switch to other channels is effected. As the period of time of a link spreads among a large number of time slots, statistical detection is also conceivable in embodiments. Here, for example, the frequency channels utilized by a base transceiver station may be iteratively scanned.

In alternative embodiments, the channel filtering, for example, could be performed in a non-analog manner, with the entire frequency band being scanned and therefore the power determination of the individual channels performed in a digital manner. In the process, the signal could be brought into a suitable intermediate frequency range, e.g. by downmixing, where the frequency band of interest may then be filtered by a band pass in order to avoid aliasing in a further sampling. Using GSM with a carrier frequency of 900 MHz as an example, this would correspond to a bandwidth of approximately 35 MHz. In order to satisfy the Nyquist requirements, the signal is then sampled such that the sampling frequency amounts to at least twice the bandwidth. The sampling rate and the intermediate frequency may in embodiments be selected such that the entire frequency band of interest completely falls upon one of the Nyquist ranges.

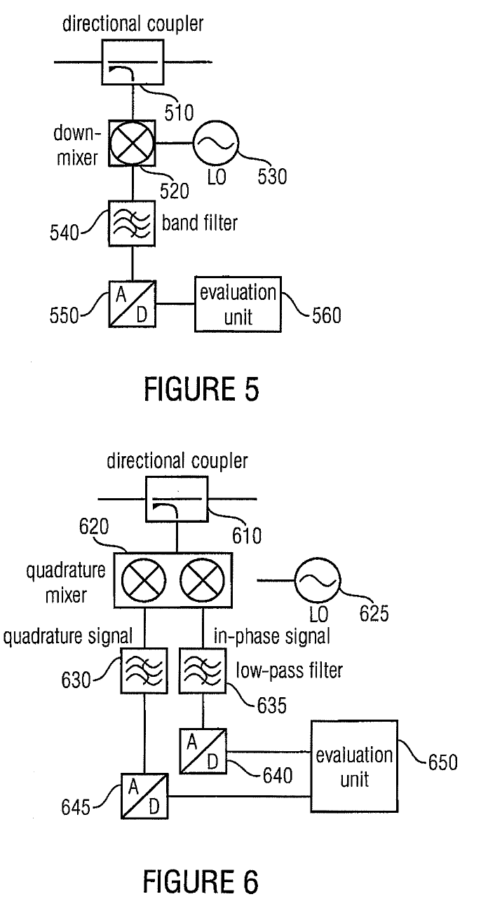

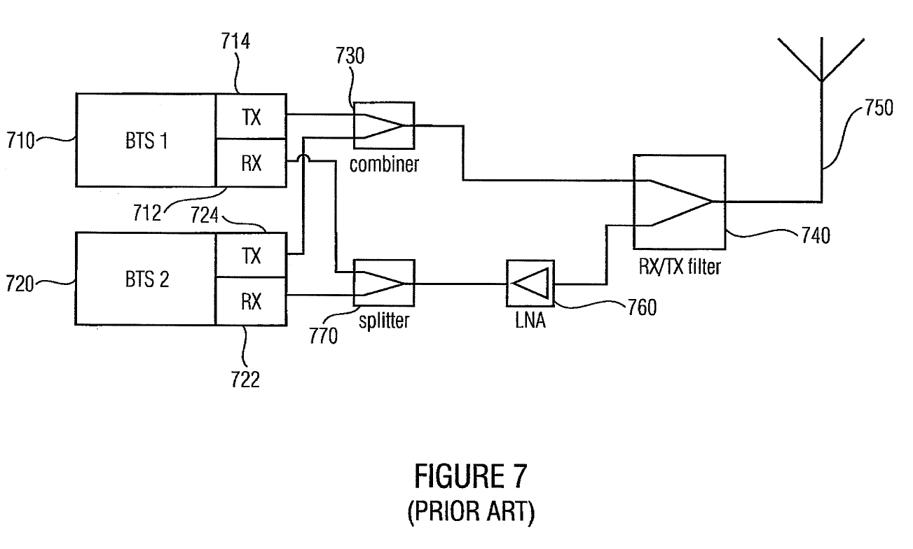

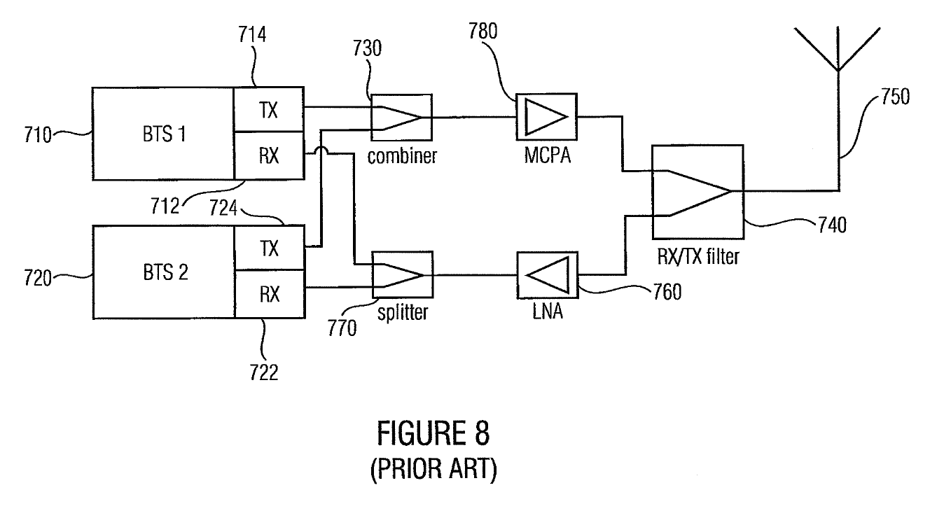

FIG. 5 shows an embodiment of such an arrangement. A directional coupler 510 couples the respective receive signal out of a receiving branch, a downmixer 520 coupled to a local oscillator 530 mixes the signal to an intermediate or base band range. A band pass filter 540 filters out the frequency range of interest, then the output signal of the band pass filter 540 is supplied to an analog-to-digital converter 550, the digitized output signal of which is provided to the evaluation unit 560. The evaluation of the respective frequency channels in the frequency range may then be entirely effected by the evaluation unit.

In other embodiments, multiple conversion may be effected, i.e. multiple mixers may be employed, which convert the respective signal across one or more intermediate frequencies.

In further embodiments, it is possible to mix the frequency band into the complex base band by direct conversion and to sample same there with two analog-to-digital converters or transformers after low-pass filtering. FIG. 6 shows such an embodiment. In FIG. 6, there is again a directional coupler 610, which may be connected into the receiving or transmitting branch of one or multiple base transceiver stations. In the embodiment of FIG. 6, the signal coupled out by the directional coupler 610 is supplied to a quadrature mixer 620 which is connected to a local oscillator 625. The quadrature mixer 620 outputs a quadrature signal and an in-phase signal, wherein the quadrature signal is supplied to a low- or band-pass filter 630 and the in-phase signal is supplied to a low- or band-pass filter 635. The output signals of the filters 630 and 635 are in turn supplied to two analog-to-digital converters 640 and 645, the digitized output signals of which are then evaluated by an evaluation unit 650. In embodiments according to FIG. 6, it may be seen to it that the complex mixer 620 achieve sufficient image frequency rejection ratio, as otherwise frequency portions from the upper band half may be imaged to the negative frequency range and vice versa, whereby measurement results could in some case be corrupted. This may be of particular relevance when large level differences are to be expected in the individual channels.

In further embodiments, in particular with the ever-increasing improvements in performance of analog-to-digital converters, direct sampling in the radio frequency range after band-pass filtering is also conceivable, wherein here, too, the sampling frequency would have to be selected in accordance with the Nyquist condition. Once a frequency band is present in the digital range, there are again several possibilities for embodiments to perform an evaluation of the frequency band in the digital range. For example, what would be conceivable is a direct Fourier transform such as a Fast Fourier Transform (FFT), according to which the power could immediately be simultaneously determined for all frequency channels. If a sampling frequency of 102.4 MHz is selected, for example, it would, in an embodiment, be conceivable to obtain, having an FFT length of 256, a value every 200 kHz, i.e. for each frequency channel, taking GSM as an example. In other embodiments, the FFT may be attributed to a larger amount of samples, the samples being present in stored form, whereby, by suitable windowing, a filtering of the data could be effected at the same time, which could be relevant for signals with a non-constant envelope, such as in EDGE.

In the digital range, embodiments may filter out each channel of interest and then determine the power thereof. This is not limited to GSM signals, as CDMA signals or OFDM signals may also be correspondingly evaluated. Embodiments may, e.g., in the digital range, shift the channels of interest into the complex base band, for example by means of digital downmixing, e.g. with the so-called CIC (Cascaded Integrator Comb) filters, the data rate may be reduced, and then interfering signal portions may be rejected by a low pass, which may be realized by an FIR (Finite Impulse Response) filter, for example. Such embodiments may also be realized by prefabricated devices or chips that already perform the digital down conversion (conversion to the base band range) and filtering. Such an embodiment could, for example, be realized by an AD6635 by Analog Devices, which is capable of processing eight channels in parallel at a sampling rate of 80 MHz. Alternatively, what would be conceivable is a GC5018 by Texas Instruments, which is capable of converting 16 channels at 160 MHz. Performance determination may be effected in embodiments by

a²=i²+q²,

for example. Embodiments therefore provide the advantage that afterwards easy demodulation is possible so as to identify the data content, for example, as it may occur, e.g., in the differentiation of dummy bursts and actual data.

In concrete applications, coupling out the receive signal via a directional coupler or power divider may be problematic, in embodiments it may also be received via a further antenna, for example. In base transceiver stations, usually antennas having high antenna gains are used. Embodiments may ensure that sufficient sensitivity is achieved, which may also be achieved by employing an antenna having a high gain, for example, and/or by a low-noise receiving circuit as it may be realized in the above-described embodiments by a low-noise radio frequency receiving amplifier (LNA), for example.

In embodiments, the power detection may also be effected in the transmit path, i.e. the circuit is connected in parallel to the above-described GSM modem either via a coupler or via an antenna. Here, embodiments offer the advantage that slight level differences between the different time slots are present at the transmitter, here, using GSM as an example, being not more than 30 dB. In these embodiments, it is then of advantage that a detected signal may very safely be allocated to the base transceiver station, even if it is received via an additional antenna. In the detection in the receive path, it may be possible that, erroneously, a signal from a terminal device registered with an adjacent cell is recognized. In the detection of the transmit signal, embodiments recognize those time slot in the BCCH frequency that do not carry information, i.e. are dummy bursts. In the GSM standard, dummy bursts are also called fill frames. The data sequences used are predefined and therefore easy to detect. In embodiments, in addition to the power detectors, a GMSK demodulator may be used, which then permits distinguishing time slots with so-called fill frames from time slots transporting actual payload data.

In the data transmission with GPRS (General Packet Radio Service), data traffic towards the terminal device may in many cases be larger than that in reverse direction. Therefore, the opportunity of using multiple time slots in one direction, if available, is given, which is not mandatory in the reverse direction. For the exact detection of the time slots used, detection in the transmit path and the receive path may also be effect in embodiments.

Embodiments of the present invention offer the advantage that, with a shared infrastructure, in particular shared antennas, the volume of data traffic in mobile radio services is allocatable to the individual mobile radio providers, whereby a utilization-dependent distribution of the installation and operating costs is enabled.

Embodiments of the present invention further provide the advantage of not having to intervene with the base station, as the inventive apparatuses and methods are based on signals that may be tapped and/or coupled out or received between the base transceiver station and the antenna. By the exact detection of the data traffic made possible by embodiments, scenarios in which multiple mobile radio providers use a base transceiver station site, a container, an antenna system, etc., have become more attractive. Therefore, embodiments essentially contribute to relaxing the critical situation on the base transceiver station site market.

Further embodiments are decoupled from the base transceiver station sites. As discussed above, each base transceiver station has a unique identification. Embodiments of the present invention may detect the utilization of an antenna by means of the transmit signals emitted from this antenna, for example. The transmit signals may, e.g., be received via an antenna so that inventive apparatuses are capable of determining the utilization proportion of an antenna even in the case that they are not coupled to the base transceiver station(s). For example, in an embodiment, an inventive apparatus could be located in the center of a mobile radio cell, wherein the base station identifiers of different mobile radio providers sharing the respective antenna to be measured be known. Embodiments of the present invention may, therefore, also be erected at sites different from the base transceiver station sites. This yields further benefits, as the implementation effort may be limited by arranging embodiments for the measurement of several sites centrally, for example.

It is particularly to be noted that, depending on the circumstances, the inventive scheme may also be implemented in software. The implementation may be effected on a digital storage medium, in particular a floppy disk, a CD or a DVD, with electronically readable control signals, which may cooperate such with a programmable computer system that the respective method is effected. In general, the invention therefore also consists in a computer program product with a program code for performing the inventive method, which is stored on a machine-readable carrier, when the computer program product runs on a computer. In other words, the invention may therefore also be realized as a computer program with a program code for performing the method when the computer program product runs on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for determining a utilized transmission capacity of a base transceiver station for transmitting a transmit signal, comprising:
a receiver, with which the transmit signal is receivable;
a detector for checking a number of utilizable transmit channels from the transmit signal for utilization thereof; and
a calculating unit for calculating the utilized transmission capacity based on a result of the check.

2. The apparatus of claim 1, wherein the detector is configured for checking the utilization of the utilizable transmit channels independently of transmitted data in the transmit channels.

3. The apparatus of claim 1, wherein the detector is configured for checking the transmit signal for utilized frequencies, time slots or codes, wherein a transmit channel is allocatable to a frequency, a time slot, a code, a plurality of frequencies or a combination thereof.

4. The apparatus of claim 1, wherein the detector is configured for checking the transmit signal for the utilization of transmit channels, in accordance with the GSM, UMTS or LTE specifications.

5. The apparatus of claim 1, wherein the detector is configured for checking a utilization of a transmit channel via power detection in the transmit signal.

6. The apparatus of claim 1, wherein the receiver comprises a receive antenna for receiving the transmit signal.

7. The apparatus of claim 1, wherein the receiver comprises a directional coupler or power divider, which is couplable in a transmit path of the base transceiver station, in order to couple out the transmit signal.

8. The apparatus of claim 1, wherein the receiver further comprises an attenuator for attenuating the transmit signal.

9. The apparatus of claim 1, further comprising a modem with which information from the transmit signal is detectable.

10. The apparatus of claim 9, wherein the modem is further configured for determining the utilizable transmit channels from a control channel of the base transceiver station.

11. The apparatus of claim 9, wherein the modem is further configured for receiving an identification of the base transceiver station.

12. The apparatus of claim 1, wherein the receiver further comprises a mixer or a local oscillator.

13. The apparatus of claim 1, wherein the receiver comprises a plurality of mixers or local oscillators.

14. The apparatus of claim 12, wherein a mixer is configured as a quadrature mixer.

15. The apparatus of claim 12, wherein a local oscillator is configured to be tunable.

16. The apparatus of claim 1, wherein the receiver further comprises a channel filter for filtering a transmit channel.

17. The apparatus of claim 1, wherein the receiver comprises a plurality of channel filters for filtering a plurality of receive channels.

18. The apparatus of claim 1, wherein the detector comprises a power detector.

19. The apparatus of claim 1, wherein the detector comprises a plurality of power detectors.

20. The apparatus of claim 1, wherein the calculating unit is preceded by a threshold-value decision unit or an analog-to-digital converter.

21. The apparatus of claim 1, wherein the detector further comprises a synchronizer for the synchronization with a waveform or a frame structure of the transmit signal.

22. The apparatus of claim 1, wherein the detector is configured for acquiring information on the utilizable transmit channels from a user.

23. The apparatus of claim 9, wherein the detector is configured for receiving information on utilizable transmit channels from the modem.

24. A method of determining a utilized transmission capacity of a base transceiver station for transmitting a transmit signal, comprising:
receiving the transmit signal;
checking a number of utilizable transmit channels from the transmit signal for utilization thereof; and
calculating the utilized transmission capacity based on a result of the check.

25. A computer program with a program code for performing, when the program code runs on a computer, the method of determining a utilized transmission capacity of a base transceiver station for transmitting a transmit signal, the method comprising:
receiving the transmit signal;
checking a number of utilizable transmit channels from the transmit signal for utilization thereof; and
calculating the utilized transmission capacity based on a result of the check.

26. An apparatus for determining a utilized transmission capacity of a base transceiver station for receiving a receive signal, comprising:
a receiver, with which the receive signal is receivable;
a detector for checking a number of utilizable receive channels from the receive signal for utilization thereof; and
a calculating unit for calculating the utilized transmission capacity based on a result of the check.

27. The apparatus of claim 26, wherein the detector is configured for checking the utilization of the utilizable receive channels independently of transmitted data in the receive channels.

28. The apparatus of claim 26, wherein the detector is configured for checking the receive signal for utilized frequencies, time slots or codes, wherein a receive channel is allocatable to a frequency, a time slot, a code, a plurality of frequencies or a combination thereof.

29. The apparatus of claim 26, wherein the detector is configured for checking the receive signal for the utilization of receive channels, in accordance with the GSM, UMTS or LTE specifications.

30. The apparatus of claim 26, wherein the detector is configured for checking utilization of a receive channel via power detection in the receive channel.

31. The apparatus of claim 26, wherein the receiver comprises a receive antenna for receiving the receive signal and a low-noise radio-frequency input amplifier.

32. The apparatus of claim 26, wherein the receiver comprises a directional coupler or a power divider, which is couplable into a receive path of the base transceiver station, in order to couple out the receive signal.

33. The apparatus of claim 26, wherein the receiver further comprises a mixer or a local oscillator.

34. The apparatus of claim 26, wherein the receiver comprises a plurality of mixers or local oscillators.

35. The apparatus of claim 33, wherein a mixer is configured as a quadrature mixer.

36. The apparatus of claim 33, wherein the local oscillator is tunable.

37. The apparatus of claim 26, wherein the receiver further comprises a channel filter for filtering a receive channel.

38. The apparatus of claim 26, wherein the receiver comprises a plurality of channel filters for filtering a plurality of receive channels.

39. The apparatus of claim 26, wherein the detector comprises a power detector.

40. The apparatus of claim 26, wherein the detector comprises a plurality of power detectors.

41. The apparatus of claim 26, wherein the calculating unit is preceded by a threshold-value decision unit or an analog-to-digital converter.

42. The apparatus of claim 26, wherein the detector further comprises a synchronizer for the synchronization with a waveform or a frame structure of the receive signal.

43. The apparatus of claim 26, wherein the detector is configured for acquiring information on the utilizable receive channels from a user.

44. The apparatus of claim 26, wherein the detector is configured for receiving information on utilizable receive channels from a modem.

45. A method of determining a utilized transmission capacity of a base transceiver station for receiving a receive signal, comprising:
receiving the receive signal;
checking a plurality of utilizable receive channels from the receive signal for utilization thereof; and
calculating the utilized transmission capacity based on a result of the check.

46. A computer program with a program code for performing, when the computer program runs on a computer, the method of determining a utilized transmission capacity of a base transceiver station for receiving a receive signal, the method comprising:
receiving the receive signal;
checking a plurality of utilizable receive channels from the receive signal for utilization thereof; and
calculating the utilized transmission capacity based on a result of the check.

47. A system for determining a utilized transmission capacity of a base transceiver station with an apparatus for determining a utilized transmission capacity of a base transceiver station for transmitting a transmit signal, the apparatus comprising:
a receiver, with which the transmit signal is receivable;
a detector for checking a number of utilizable transmit channels from the transmit signal for utilization thereof; and
a calculating unit for calculating the utilized transmission capacity based on a result of the check.

48. A system for determining a utilized transmission capacity of a base transceiver station with an apparatus for determining a utilized transmission capacity of a base transceiver station for receiving a receive signal, the apparatus comprising:
a receiver, with which the receive signal is receivable;
a detector for checking a number of utilizable receive channels from the receive signal for utilization thereof; and
a calculating unit for calculating the utilized transmission capacity based on a result of the check.
